(19) United States
(12) Patent Application Publication
(10) Pub. No.: US 2010/0064300 A1
(43) Pub. Date: Mar. 11, 2010

(54) System and method for providing applications and peripherals to a fixed price component-based computing platform

(76) Inventor: Robb Fujioka, Manhattan Beach, CA (US)

Correspondence Address: Drinker Biddle & Reath LLP, One Logan Square, 18th and Cherry Streets, Philadelphia, PA, 19103-6996, US

(21) Appl. No.: 12/459,171

(22) Filed: Jun. 26, 2009

Related U.S. Application Data
(60) Provisional application No. 61/090,054, filed on Aug. 19, 2008.
(60) Provisional application No. 61/106,645, filed on Oct. 20, 2008.

(51) Int. Cl. G06F 9/54

(52) U.S. Cl. 719/321; 719/328

(57) ABSTRACT

An apparatus, system and method of open platform computing. The present invention may include at least one microprocessor, a computer case that encases the at least one microprocessor, at least one operating system resident on the at least one microprocessor, wherein the at least one operating system includes an open platform for accepting a plurality of applications and hardware not presented as forming a portion of, and absent the plurality of applications not being operable by, the at least one operating system, at least three ports in the computer case, wherein the ports are communicatively electrically connected to the at least one microprocessor, and wherein at least one of the plurality of applications is applied at least one of the ports for presentation by the at least one microprocessor via the at least one operating system.

### CROSS-REFERENCE TO RELATED APPLICATIONS

The present invention claims priority to U.S. Provisional Patent Application No. 61/090,054, entitled “MODULAR APPLICATION COMPUTING APPARATUS, SYSTEM AND METHOD” filed Aug. 19, 2008, and to U.S. Provisional Patent Application No. 61/106,645, entitled “SYSTEM AND METHOD FOR PROVIDING APPLICATIONS AND PERIPHERALS TO A FIXED PRICE COMPONENT-BASED COMPUTING PLATFORM” filed Oct. 20, 2008, the entire contents of which are incorporated herein by reference.

### BACKGROUND OF THE INVENTION

1. Field of the Invention

The present invention relates generally to computers and computing applications and, more particularly, to a modular application computing apparatus, system and method.

2. Description of the Background

At present, typical home and office computing methodologies provide hardware and software in a relatively “one size fits all” mentality. That is, computers at present provide, at different levels of expense, certain hardware and software capable of performing certain functions and providing certain speeds, memory, and the like, for all purchasers at each price level. Thereby, it is inevitable at each price point in the present computer market that a purchaser will pay for hardware and/or software that he or she does not intend to, and in fact will not, make use of. Further, in the event the purchaser wishes to make a change in that which he or she will make use of in a “one size fits all” computer presented for purchase, the purchaser must typically either request such change at the time of purchase of the computing system, or must have sufficient expertise to make the desired modifications him or herself subsequent to purchase, or must be willing to make significant expenditures after purchase to have another make the desired modifications.

Therefore, the need exists for a life style oriented computing solution that provides a cloud computing solution in an open platform format, that is, that provides a computing solution that allows a user to use, and purchase, principally the hardware and only the software that the user will make use of, and that later allows a user to inexpensively and easily add features to the purchased computing solution as those features become desirable to the user.

### SUMMARY OF THE INVENTION

The present invention provides an apparatus, system and method of open platform computing. The present invention may include at least one microprocessor, a computer case that encases the at least one microprocessor, at least one operating system resident on the at least one microprocessor, wherein the at least one operating system includes an open platform for accepting a plurality of applications and hardware not presented as forming a portion of, and absent the plurality of applications, not operable by, the at least one operating system, at least three ports in the computer case, wherein the ports are communicatively electrically connected to the at least one microprocessor, and wherein at least one of the plurality of applications is applied at least one of the ports for presentation by the at least one microprocessor via the at least one operating system.

Thus, the present invention provides a life style oriented computing solution that provides a cloud computing solution in an open platform format, that is, that provides a computing solution that allows a user to use, and purchase, principally the hardware and only the software that the user will make use of, and that later allows a user to inexpensively and easily add features to the purchased computing solution as those features become desirable to the user.

### BRIEF DESCRIPTION OF THE FIGURES

The present invention will be described hereinbelow in conjunction with the following figures, in which like numerals represent like items, and wherein:

FIG. 1 illustrates an exemplary embodiment of the present invention;

FIG. 2 illustrates an exemplary embodiment of the present invention; and

FIG. 3 illustrates an exemplary embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention provides a lifestyle oriented computing solution. More specifically, current home and office computing methodologies provide hardware and software in a relatively “one size fits all” mentality. That is, computers at present provide, at different levels of expense, certain hardware and software capable of performing certain functions and providing certain speeds, memory, and the like, for all purchasers at each price level. Thereby, it is inevitable at each price point in the present computer market that a purchaser will pay for hardware and/or software that he or she does not intend to, and in fact will not, make use of. The present invention provides a life style oriented computing solution in that it provides a cloud computing solution in an open platform format, that is, it provides a computing solution that allows a user to use, and purchase, principally the hardware and only the software that the user will make use of. Further, in the event the purchaser makes a change in that which he or she will make use of, the present invention allows for the purchaser to readily and easily modify the initial computing solution to encompass the new need that has arisen.

Thus, in one exemplary embodiment, the present invention may include an open platform computer made up of at least one microprocessor, a computer case that encases the at least one microprocessor, and at least one operating system resident on the at least one microprocessor. The at least one operating system may include an open platform for accepting a plurality of applications not presented as forming a portion of the at least one operating system. There may be any number of ports, such as at least three ports, in the computer case, and the ports may be communicatively electrically connected to the at least one microprocessor. Finally, the at least one of the plurality of applications may be applied at least one of said ports for presentation by the at least one microprocessor via the at least one operating system.

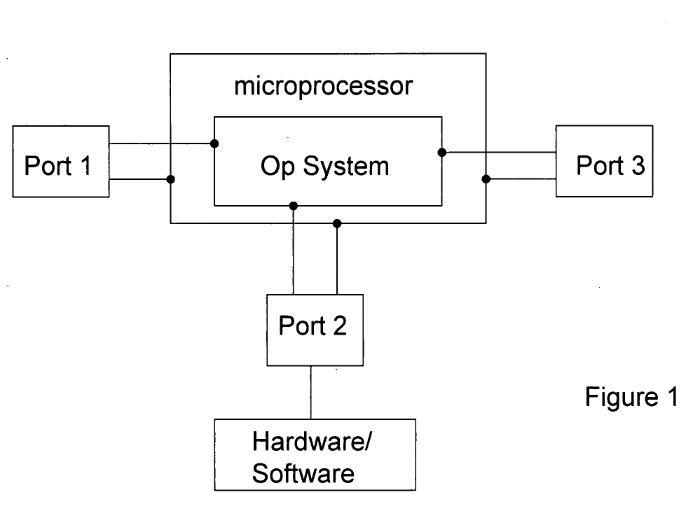

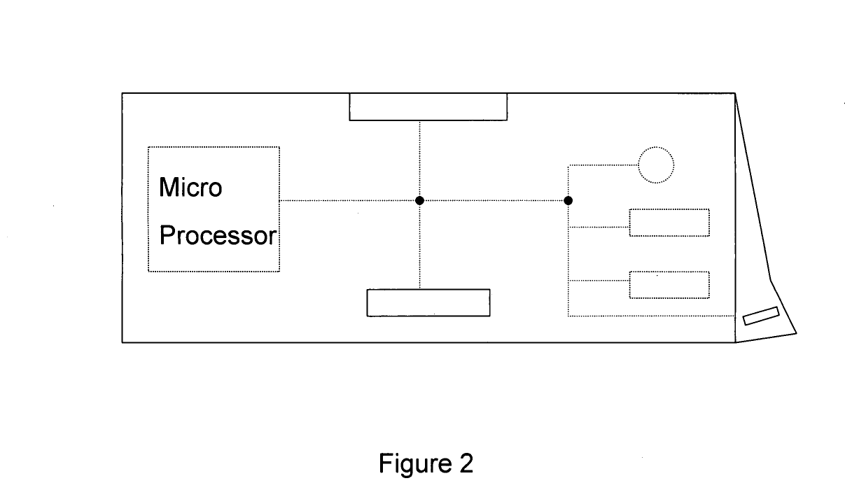

In fact, through the use of the present invention, the purchaser can be provided with solutions other than strictly computing solutions, that is, the user can be provided with replacement technology for other technologies and/or items in and around an office or a household, as will be further explained hereinbelow. More specifically, FIG. 1 illustrates a block diagram of the open platform solution provided by the present invention. FIG. 2 illustrates a schematic embodiment of the hardware provided by the present invention.

With reference to FIGS. 1 and 2, the present invention provides a computing solution capable of driving only that hardware, that software, those appliances, and those peripherals desired to be driven by a user of the instant computing solution. Thereby, the present invention provides a modular computing solution that not only introduces modular revenues for the computing industry, but that additionally provides a computing solution that can be developed uniquely by each user for that user's life style profile. For example, modules may be added for use with the present invention that provide internet computing, word processing computing, a set top box, a recipe system for use in a kitchen, or an iPod/MP3 player/radio for use by a swimming pool. Such myriad capabilities may be modularly provided, that is, may be separately made available and/or purchased for use with the initially purchased base computing system.

The base computing system preferably provides an open platform for use in the present invention. The base computing system may be, for example, a Linux based machine, and/or may employ open source software and platforming, and/or may thus provide an openware solution. Such an “open format” computer may provide only that desired by the user in a base model computer. Thus, for example, as illustrated in FIG. 2, the computing device of the present invention at the base level may be provided with a plurality of USB, Ethernet, RCA, Optical, and like inputs, into which may be connected any number of appliances, peripherals, software modules, and the like. Such input ports may include, for example, a hardware and software port at the top of the unit, in the center and facing upward, ports on the front, sides, back, and even on the stand for the unit, and/or a power port, for example. Any mix of types of such ports, and in any locations, may be provided. Further, an application may, in certain embodiments, entail provision of application software at one port of the present invention, and operation of application specific hardware correspondent to the application software at one or more other ports. Ports may, for the purposes discussed herein, be interchangeable as to what is applied to any given port in a particular application, and may not be interchangeable for the purposes of other application modules. Additionally, the unit may be enabled to operate for periods of time, or permanently, on one or more batteries, rather than a plug-in power supply.

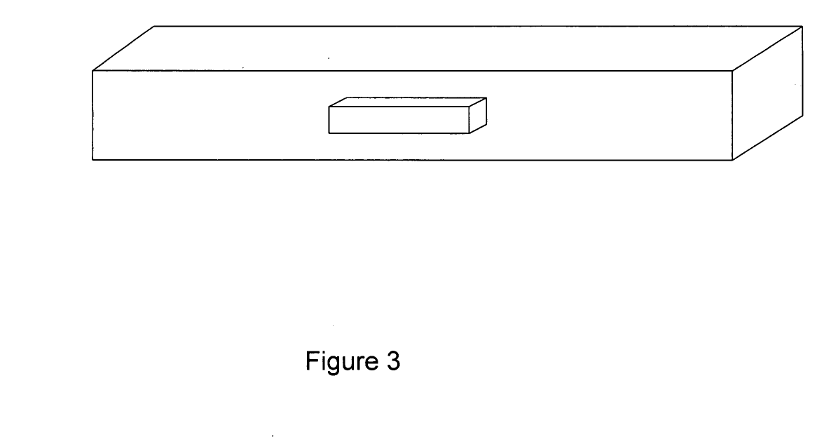

In light of the discussion herein, those skilled in the art will understand that myriad physical embodiments of the computing solution of the present invention may be made available. In an exemplary embodiment, a computing system of the present invention may be, for example, as illustrated in FIG. 3, a small computing “brick”, such as a three inch by four inch by half-inch thick brick. In such an embodiment, for example, the brick may most simplistically include one simple male or female connector, such as at the top portion of the brick, and may additionally include only minimal computing capabilities, such as one or more RAM memory, one or more hard drives, or the like. In such an embodiment, power, hard drives, memory, micro processing capabilities and the like may all be connected via the single brick connection, thereby allowing for minimization of the hardware necessary in the base computing brick. As will be understood by those skilled in the art, the computing brick may thus include only a rudimentary operating system, and/or may operate based only on machine language wherein an operating system is communicatively connected via the machine language to the computing brick from an external module through the single port, for example. Thereby, the base computing system discussed in the present invention may be and include a minimalistic computing system constituted by a brick having an operating system that, in total, approximates the size of a Post-It® note tablet. Thereby, the base computing solution of the present invention may be placed into numerous different design modules to allow for numerous different form factors, thus enabling the aesthetic modifications and various appliance usages discussed herein throughout. For example, the base computing brick may be placed into a larger computing system to create a word processing, or email, solution, for example. Likewise, the base computing solution may be dropped into a lamp, a refrigerator, or a toaster to provide computing functionality in everyday appliances, and/or may be readily interchanged as upgraded base solutions are created, and/or as initial base computing solutions or appliances reach the end of useful lifetimes. Thus, any appliance or computing system into which the brick is placed may preferably include a physical accommodation for the brick (such as a suitably sized well into which the brick may be placed), and/or one or more ports to mate with the brick port(s). Likewise, all peripherals discussed herein may connect with the base computing solution, such as via the single brick connector, to form different form factors, such peripherals including, for example, screens, keyboards, foldable keyboards, mice, printers, photo printers, and the like.

More specifically, in an exemplary embodiment of the present invention, a user may purchase, inexpensively, such as for ninety-nine dollars, a base computing system. Resident on that base computing system may be only limited operating system software, such as Linux based operating system software, such as a thin client or thick client operating system, such as the UrSpin operating system made by Fuhu. The operating system of the present invention may provide, upon implementation and/or purchase of the computer, no, or very limited, application functionality. However, the user may be enabled to add on application hardware/software modules to provide functional computing aspects for execution by the open operating system. For example, in certain embodiments, the base computing system may be provided with a computing screen and may otherwise simply be a black box with a plurality of ports therein and a computing screen. The user may purchase a word processing module, wherein, for a limited expense in addition to the base computing system, the user is provided with word processing software for execution with the operating system, along with a computing mouse and keyboard, and/or, in certain embodiments wherein a screen is not provided, a screen having only a USB male connector to mate with a USB female connector at the lower front of the base unit, for example.

In an additional alternative embodiment, the instant invention may be equipped as a modular photograph computing solution. For example, a user may purchase a module consisting of a variety of peripherals for attaching to cameras, and/or a camera, and further software for communicating with such cameras, and additionally software for downloading and/or processing and/or manipulating photographs. Additionally or alternatively, such a computing solution may allow for, or come with, a photo printer module for plugging in to the instant computing solution.

In an additional alternative embodiment, the instant computing solution may be sold at a low price, such as ninety-nine dollars, as a bundled, dedicated computing solution. For example, such as for office use, the instant invention may be bundled and sold as a conferencing center. For example, the aforementioned operating system may be populated with one or more conferencing solutions, such as networked, audio and/or video conferencing, and/or with certain conferencing software, such as the Skype® conferencing solution. Such a conferencing computing solution may include, for example, an online video camera for use with videoconferencing, a plug and play microphone and/or speaker system, a computing screen, which may be built into the main unit as mentioned hereinabove, and a control pad, either in software or in a hardware keyboard format, or in both formats, for example.

In an additional alternative embodiment, the instant invention may be bundled for use as a digital picture frame. However, needless to say in light of the discussion hereinabove, a digital picture frame provided by the instant invention would be far more powerful from a computing standpoint than conventional digital picture frames. For example, the aforementioned “box” purchased by a user may, in a digital picture frame embodiment, come with a preinstalled digital picture frame operating system, which may include, for example, capabilities for downloading pictures, uploading pictures, interfacing with internet sites on which are resident pictures, software for manipulating pictures, and the like. Further, such a digital picture frame embodiment may come equipped with a plurality of ports into which can be plugged any of a myriad of storage devices on which are resident pictures, which storage devices may then be read by the digital picture frame operating system. Further, for example, unlike conventional digital picture frames, this exemplary embodiment of the present invention may be capable of offloading pictures from the operating system to external storage devices through the use of the aforementioned ports.

Thus, in an exemplary embodiment of the brick discussed hereinabove, via a male or female single top connector, a screen may be provided, along with a dongle having resident thereto, one or more applications for implementation by the base computing brick. Thereby, the screen may include, for example, a battery that operates both the screen and the base computing brick, and a dongle that provides, among other operations, a digital picture frame operation for use with the base brick computing system. Such digital picture frame operation may include, for example, presentation of a multi-option clock, wherein the clock and clock display type may be changed, the clock may display one or multiple times in different time zones, the weather may be displayed via an available network connection that may be resident in either the screen or in the brick, and/or news via the network communication may be delivered, all in addition to the typical display of family and friend photos provided by digital picture frame.

Alternative embodiments may include more specifically software based module applications. For example, an auction based computing solution may be purchased in the present invention, in which only on-line auction-based software is provided for use by the user through the operating system. Further, such auction based software may be an allowance to link to on-line auction sites, or may be an independent software solution that monitors such sites, but in a format unique to the present invention. Such an application based bundle or module may include the aforementioned on-line auction software solution, a mouse, a keyboard, and an internet access solution, and no additional or wasted software or hardware. Such module software may be provided in any known format for use in the instant invention, such as being loaded via a USB port from, for example, a memory stick or the like.

Additionally, as mentioned hereinabove, the present invention may provide module appliance based solutions. For example, the present invention may be purchased as an email module, wherein the machine is dedicated to receiving and sending emails, and wherein the machine includes a foldable screen of any desired size, and a built-in or external keyboard or mouse. However, unlike the prior art, such an email module may be provided as a programmable or non-programmable power strip, and/or in fact may be designed to appear as a lamp base or the like. In such an embodiment, the user may be able to program the power strip to turn the lamp on or off at a desired interval, or may simply use the power strip as connected to a wall switch to turn the lamp on or off. Further, the lamp may be or include a light indicating email has been received, or in fact the machine may turn on the aforementioned lamp when email has been received. Upon receipt or desire to send email, the user may access the small hidden screen and/or keyboard and mouse to engage with the email program, and, after use, may return the hidden items to the appearance of a lamp base. It will be well understood by those skilled in the art that the aforementioned appliance related example is made only by way of example, and that any number of appliance based applications may be indicated in the present invention.

In a further example of an appliance based application, a user may purchase the instant invention as either a radio bundle, or may purchase a radio module for use with the present invention. Such a radio based application device may include, for example, USB plug-in mini-speakers, interactive radio elements such as volume, treble, and bass controls, a manner of displaying a song being played, a radio station tuned to, and/or an artist, and which may additionally display graphics associated with a song or songs, and software capable of interacting with the operating system to download, upload, and play music from any of a variety of locations and in any of a variety of formats. For example, such an application based radio device may interface with online sites at which a user has stored favorite music, may allow for download from CD's, may include a radio tuner, and/or may include an interface to download from any of a variety of formats, such as from MP3 players or the like. In such an embodiment, a radio appliance may be provided by the present invention, which radio appliance, unlike the prior art, includes a far more powerful operating system along with the ability to download from any of many locations, including, perhaps, from the Internet, and to play music in any location just as would a standard radio appliance.

The aforementioned exemplary embodiments are non-limiting. For example, myriad other possibilities for discrete application modules will become apparent to those skilled in the art in light of the disclosure herein, and particularly in light of the type and location of hardware-accepting ports discussed herein. Such application will include, for example, providing modular applications that provide Internet browsing, email, newspaper(s), telephone, television, alarm clock, and the like.

For the sake of clarity, “applications” as discussed herein are not intended to be, although they may include, merely driver software. For example, the prior art, on occasion, provides a hardware device bundled with driver software, which driver software, when interacted with one or more applications in an operating system in the presence of the hardware that is to make use of the driver software, allows for operation of the hardware by the operating system to occur. However, contrary to the prior art, the present invention provides an operating system that typically does not have an application resident thereon to execute driver software for the hardware of the modules of the present invention. Rather, the present invention provides the necessary hardware, and often the driver software, and the application for interacting with the necessary hardware via the operating system, discretely with each separately obtained bundle.

Due to the module and/or bundled nature of the instant invention, the instant invention provides many advantages over prior art applications. For example, because of the functionality of the instant invention as a dedicated machine dedicated to certain purposes, the instant invention needs only provide sufficient security for the purpose for which the instant invention is being used. For example, for most applications of the present invention, no passwords or other security are necessary, in part because there is little or no information to hack or steal, thereby simplifying use and the speed to which a user can put the instant device to use. Further, the instant invention allows for the addition only of desired modules, or application packs, such as via USB ports. Thereby, through the exposure of numerous interface ports, the instant invention allows for the addition of the aforementioned application packs in the form of applications, such as software applications, peripherals, and even appliances, unlike the prior art which limits and/or endeavors to hide the input ports. Further, the present invention is advantageous in that it provides only what a user needs in order to perform the desired functionality, thereby limiting that with which the user needs to interface, and additionally limiting that which the user needs to learn how to operate. Further, the aforementioned modules and/or application packs may be provided with differing elements based on those elements that may make for an improved user experience. For example, a dedicated email machine may be provided with a bigger screen for ease of viewing, and may be provided with a full size keyboard for ease of typing. Further, as mentioned hereinabove, such an email device user need only learn how to use that screen, that keyboard, and that email program, and need not learn about complex unnecessary software, video drivers, and the like.

Further, it will be appreciated by those skilled in the art that the instant invention may provide for a myriad of marketing and sales opportunities. For example, the openware operating system, such as a Linux based operating system, which may be provided on the present device, may, in all or certain embodiments, or bundles, or certain uses, additionally include a preferred search engine, for which the user may pay a token amount included in or in addition to the low price of the present invention device. Additionally, the present invention may require registration of those bundles, modules, and/or application packs upon purchase by the user, and thus may provide information about the preferences of users, the economics of such users, and the computing usage of such users, for example. Further, because of the open platform solution of the instant invention, any entities may create and/or market modules for use with the instant invention.

As discussed briefly above, the present invention also provides for the purchase of the aforementioned bundles and appliances/peripherals compatible with the base computing system. The base computer system may be bundled with certain applications or peripherals while others may be obtained downstream from the purchase of the base computing system. By way of non-limiting example only, the base unit may be bundled with a video display and keyboard device wherein the bundle may be used as an email and internet gateway. By way of further example, both the keyboard and video display may be plug and play and each may use a fixed or remote form of connectivity to the base computing system.

After purchase of this type of bundle, further add on applications and peripherals may be purchased as needed. For example, the purchaser of this type of bundle may also wish to purchase a suite of “office” software which may include, for example, word processing and presentation development software. Such a suite of software may be sold as a stick or chip, for example, that would have connectivity with the base computer system. The most general form of such a suite peripheral would be in the form of a UBS compatible stick. This would allow for the greatest amount of plug and play connectivity. By way of further example, as discussed above, such connectivity may also be achieved through the use of bluetooth, wi-fi or other wireless connections. Such delivery may also be compatible with RFID, for example.

Although some examples have been described above, peripherals may allow content such as radio, newspapers, email, music, telephone, T.V., and calendars, for example, to be viewed and interacted therewith. Although Internet conductivity may provide real-time access to such content, the peripherals may also contain sufficient stored or obtained content to function independent of any remote content source. By way of non-limiting example only, books may be offered for listening on speakers pre-loaded with such content which speakers may then connect wirelessly and become activated and controlled when in proximity to the base computing system.

Appliances, whether pre-programmed or not, may include stereo components, radio and T.V. interfaces, telephone(s), speakers, video recorders/cameras, tele-conferencing technology, clocks, hard-wired, wireless and virtual keyboards, memory storage, lamps, digital photo frames, messaging services and any other peripheral that would benefit from connectivity to the base computing. Appliances may also incorporate application to enhance the base computing system. The software appliances may include financial and artistic applications, as well as word processing, database, email, and presentation applications, for example. Applications may also allow for increased and enhanced connectivity for third party applications, such as Ebay®, Facebook®, Twitter®, Skype®, Napster®, Itunes®, and other interactive sites. These applications may be bundled with internet access software and may allow for plug and play capability.

In this capacity, the present invention allows for the purchase of only necessary appliances and applications. For example, a retired person may which to communicate via email to friends and family. The purchase of a keyboard appliance and a video screen appliance may be all that is necessary to be added to the base computing system for such email access. Depending on the services provided in the base computing system and/or in the appliances purchased for this particular purpose, the user may additionally need an internet or email application. Either way, the user has purchased the minimum necessary to accomplish the act of email communication.

Additionally, such appliances and peripherals may be used in conjunction when desired. For example, the base computing unit may be coupled with an LCD screen, video camera, microphone, speakers and Skype® software to facilitate a video call with a third party in a distant country. By way of further example, the base computing system may be coupled with a keyboard, LCD screen and a Facebook® appliance to facilitate social networking. As one skilled in the art can appreciate, the combinations and variety of appliances and applications makes possible an almost limitless array of computer-supported functionality. As can also be appreciated from the examples provided above, a user of the base computing system is free to add or subtract any appliance or application which the user deems need or unnecessary for the functionality desired at that particular time.

In an embodiment of the current invention, the base computing system may also act as a hub or independent arbiter of larger systems, either organically or through the use of appliances and/or applications. When used in a networked format, at least two base computing systems may act in concert to control one or more desired functions. The at least two base computing systems may work in concert to improve computing power and/or to improve communications between at least one base computing system and at least one appliance or peripheral. For example, a home alarm system may be monitored and/or controlled by at least one base computing system and may allow for user control of the alarm system and third party prompting by the triggering of the alarm system. By way of further example, a base computing system may be located on each floor of the structure to increase connectivity with the various floor monitors.

Further, traditional appliances, such as ovens, washing machines, garage door openers, lighting, intercoms, non-invention computers, and other similar home technology, for example, may be controlled or able to receive commands from at least one computing base station. Such an array of home electronics, may, for example, be controlled remotely by the user or through the use of pre-inputted information by the user. By way of non-limiting example only, a base computing system may turn off the lights in a user's dining room at a predetermined time each night. The user may incorporate the present invention into a smart kitchen or smart home whereby the user can control not only the gadgets of the house but also the environment as a whole. In this capacity, for example, each of the ones of base computing systems may handle many functions including the regulation of a “smart house.”

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. An open platform computer, comprising:
at least one microprocessor;
a computing module comprising said at least one microprocessor, and having a single port for communicatively electrically connection to the at least one microprocessor;
at least one operating system resident on the at least one microprocessor, wherein said at least one operating system comprises an open platform for accepting a plurality of applications, wherein each of the plurality of applications is correspondent to at least one hardware device discrete from said computing module and at least one software device discrete from said at least one operating system; and
wherein at least one of the plurality of applications is applied via the single top port by the at least one microprocessor to operate the at least one discrete hardware device in accordance with the at least one software device using said at least one operating system.

2. The open platform computer of claim 1, wherein the at least one discrete hardware device is remote from said computing module.

3. The open platform computer of claim 1, wherein the at least one discrete hardware device is selected from the group consisting of an appliance and peripheral.

4. The open computer platform of claim 1, wherein said computing module remotely communicates with at least one other computing module.

5. The open computer platform of claim 1, wherein said at least one microprocessor remotely communicates with the internet.

6. The open computer platform of claim 1, wherein said at least one microprocessor remotely communicates with the discrete hardware device comprising an appliance.

7. The open computer platform of claim 1, wherein said at least one microprocessor remotely communicates with the discrete hardware device comprising a peripheral.

8. The open computer platform of claim 1, wherein said at least one microprocessor is communicatively coupled with at least one keyboard and at least one video monitor.

9. The open computer platform of claim 1, wherein said at least one of the plurality of applications is obtained via remote connectivity.

10. The open computer platform of claim 1, wherein said at least one discrete hardware device alerts a user to queued information.

11. The open computer platform of claim 1, wherein said at least one microprocessor remotely receives information to be queued for use by at least one selected from the group consisting of a user and said at least one of the plurality of applications.

12. The open computer platform of claim 1, wherein said at least one microprocessor is remotely communicative with one selected from the group consisting of an appliance, a peripheral and a utility.

13. A method of providing an open computer platform, comprising the steps of:
providing at least one microprocessor;
providing a computing module comprising at least one microprocessor, and having a single top port communicatively electrically connected to the at least one microprocessor; and
providing at least one operating system resident on the at least one microprocessor, wherein said at least one operating system comprises an open platform for accepting a plurality of applications non-native to said at least one operating system, wherein each of the plurality of applications is correspondent to at least one hardware device discrete from said computing module and at least one software device discrete from said at least one operating system; and
wherein at least one of the plurality of applications is applied to at least to the single top port to operate the at least one discrete hardware device via the at least one software device using said at least one operating system.

14. The method of claim 13, wherein the at least one discrete hardware device is remote from said computing module.

15. The method of claim 13, wherein the at least one discrete hardware device is selected from the group consisting of an appliance and peripheral.

16. The method of claim 13, wherein said computing module remotely communicates with at least one other computing module.

17. The method of claim 13, wherein said at least one microprocessor remotely communicates with the internet.

18. The method of claim 13, wherein said at least one microprocessor remotely communicates with the discrete hardware device comprising an appliance.

19. The method of claim 13, wherein said at least one microprocessor remotely communicates with the discrete hardware device comprising a peripheral.

20. The method of claim 13, wherein said at least one microprocessor is communicatively coupled with at least one keyboard and at least one video monitor.

21. The method of claim 13, wherein said plurality of applications is obtained via remote connectivity.

22. The method of claim 13, wherein said at least one discrete hardware device alerts a user to queued information.

23. The method of claim 13, wherein said at least one microprocessor remotely receives information to be queued for use by at least one selected from the group consisting of a user and said at least one of the plurality of applications.

24. The method of claim 13, wherein said at least one microprocessor is remotely communicative with one selected from the group consisting of an appliance, a peripheral and a utility.
